(19) United States
(12) Patent Application Publication
(10) Pub. No.: US 2014/0311981 A1
(43) Pub. Date: Oct. 23, 2014

(54) Systems and Methods for Concentrating Sugar Content of Liquids

(71) Applicant: Maple Expert Solutions, Inc., Manchester, NH (US)

(72) Inventors: Clayton G. Christie, Jefferson, NH (US); Daniel B. Crocker, Putney, VT (US)

(73) Assignee: Maple Expert Solutions, Inc., Manchester, NH (US)

(21) Appl. No.: 14/257,728

(22) Filed: Apr. 21, 2014

Related U.S. Application Data
(60) Provisional application No. 61/813,846, filed on Apr. 19, 2013.

(51) Int. Cl. B01D 61/02; B01D 61/12

(52) U.S. Cl. CPC B01D 61/025; B01D 61/12
USPC 210/652; 210/96.2

(57) ABSTRACT

Reverse-osmosis-based concentrators for automatedly concentrating the sugar content of liquids to a desired sugar content. In some embodiments, the concentrator includes a variable-pressure pumping system designed, configured and controlled to maintain a desired pressure within one or more reverse-osmosis units. In some embodiments the concentrator includes an automated concentrate bleed system designed and configured to automatedly control an amount of concentrate bled from the concentrator as a function of a predetermined sugar content of the liquid. Corresponding methods of concentrating sugar are also disclosed. In some methods, sugar is concentrated by automatedly controlling pressure of the liquid within one or more reverse-osmosis units. In some methods sugar is concentrated by automatedly controlling output of a concentrate from the one or more reverse-osmosis units as a function of a sugar content of the liquid.

### RELATED APPLICATION DATA

This application claims the benefit of priority of U.S. Provisional Patent Application Ser. No. 61/813,846, filed on Apr. 19, 2013, and titled “CONCENTRATOR SYSTEMS AND METHOD FOR MAPLE SYRUP PRODUCTION,” which is incorporated by reference herein in its entirety.

### FIELD OF THE INVENTION

The present invention generally relates to the field of sugar concentrators. In particular, the present invention is directed to systems and methods for concentrating sugar content of liquids.

### BACKGROUND

Various naturally occurring liquids, such as maple sap and coconut milk, among others, contain sugar, and it is often desired to concentrate the sugar in these liquids. For example, the sugar in maple sap is concentrated during the process of producing maple syrup. In typical conventional maple syrup production, the sugar content of raw maple sap is concentrated using a reverse-osmosis (RO) system that includes one or more fixed-speed pumps and motors to provide the pressure needed for the reverse osmosis to occur in the RO unit(s) of the system. This reverse-osmosis pressure is typically controlled by hand using one or more hand-operated valves. The concentrate output of the RO unit(s) is recirculated to the RO unit(s) until a desired sugar concentration is reached. Typically, the amount of sugar in the recirculated concentrate is measured using a hand-held refractometer, and when an operator decides that the sugar concentration is at the right level, they open a hand-operated valve to draw concentrate out of the RO system.

### SUMMARY OF THE DISCLOSURE

In one implementation, the present disclosure is directed to a method of increasing sugar concentration in a liquid containing sugar. The method includes receiving a sugar-concentration setpoint; providing the liquid to an inlet to a concentrate side of a reverse-osmosis (RO) unit under an RO pressure that causes water in the liquid to permeate through an RO membrane of the RO unit to a permeate side of the RO unit; recirculating a concentrate of the liquid from an outlet of the concentrate side of the RO unit to the inlet of the concentrate side of the RO unit; automatedly monitoring the sugar concentration of the concentrate to obtain a sugar-concentration measurement; automatedly comparing the sugar-concentration measurement to the sugar-concentration setpoint; and when the sugar-concentration measurement is equal to or greater than the sugar-concentration setpoint, automatedly actuating a concentrate-draw valve to draw concentrate from the recirculating.

In another implementation, the present disclosure is directed to a sugar concentrator designed and configured to increase the concentration of sugar in a liquid. The concentrator includes a reverse-osmosis (RO) unit containing an RO membrane defining a concentrate side and a permeate side of the RO unit, the concentrate side having a liquid inlet and a concentrate outlet, and the permeate side having a permeate outlet; a feed system designed and configured to feed the liquid to the liquid inlet of the RO unit; a recirculation loop fluidly coupling the concentrate outlet of the RO unit to the liquid inlet of the RO unit so as to recirculate a concentrate from the concentrate side of the RO unit back to the concentrate side during operation of the sugar concentrator; an automated concentrate draw valve fluidly coupled to the recirculation loop so as to controllably draw a portion of the concentrate off of the recirculation loop during operation of the sugar concentrator, the automated concentrate draw valve responsive to a valve-control signal so as to change flow of the concentrate through the automated concentrate draw valve during operation of the sugar concentrator; a sugar sensor designed and configured to automatedly sense a sugar concentration of the concentrate recirculating in the recirculation loop during operation of the sugar concentrator, wherein the sugar sensor generates a sugar-concentration-measurement signal as a function of the sugar concentration; and a controller in operative communication with each of the sugar sensor and the automated concentrate draw valve, the controller designed and configured to generate the valve-control signal as a function of the sugar-concentration-measurement signal.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a high-level block diagram of an exemplary sugar concentrator made in accordance with the present invention;

FIG. 2 is a schematic diagram of an exemplary sugar concentrator made in accordance with the present invention;

FIG. 3 is a diagram illustrating an exemplary programmable logic controller (PLC) event sequence for auto-priming and sugar concentration operations of the concentrator of FIG. 2;

FIG. 4 is a diagram illustrating an exemplary PLC event sequence for purging operations of the concentrator of FIG. 2; and

FIG. 5 is a diagram illustrating an exemplary PLC event sequence for wash and rinse operations of the concentrator of FIG. 2.

### DETAILED DESCRIPTION

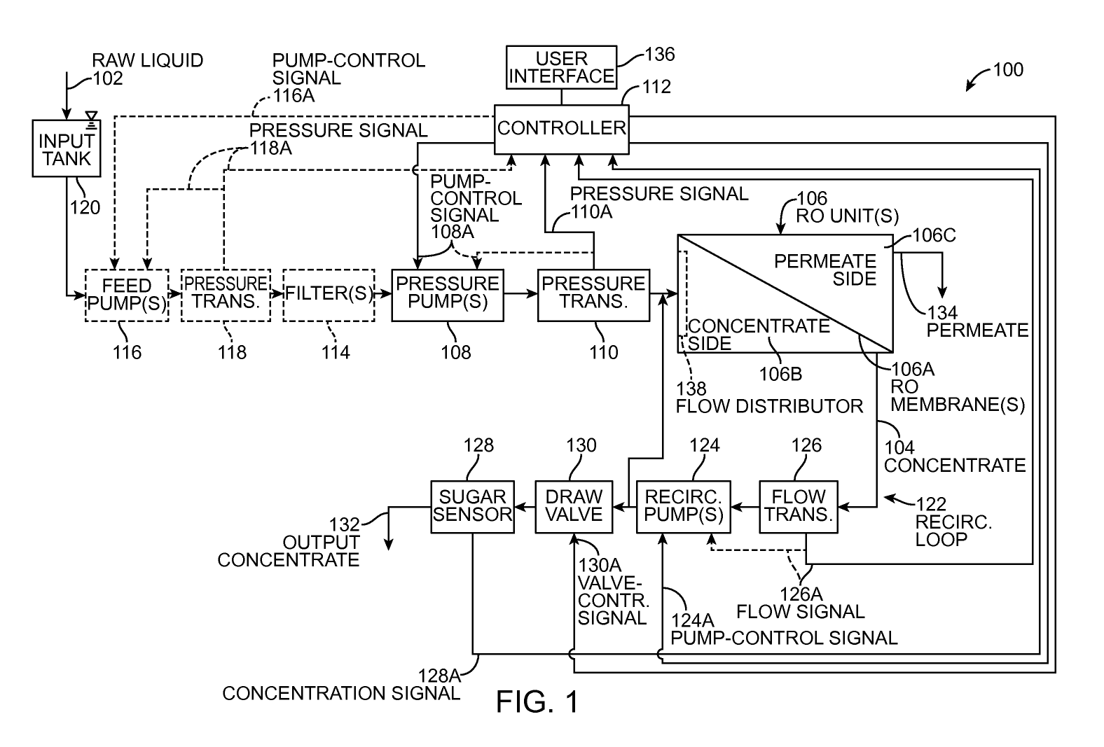

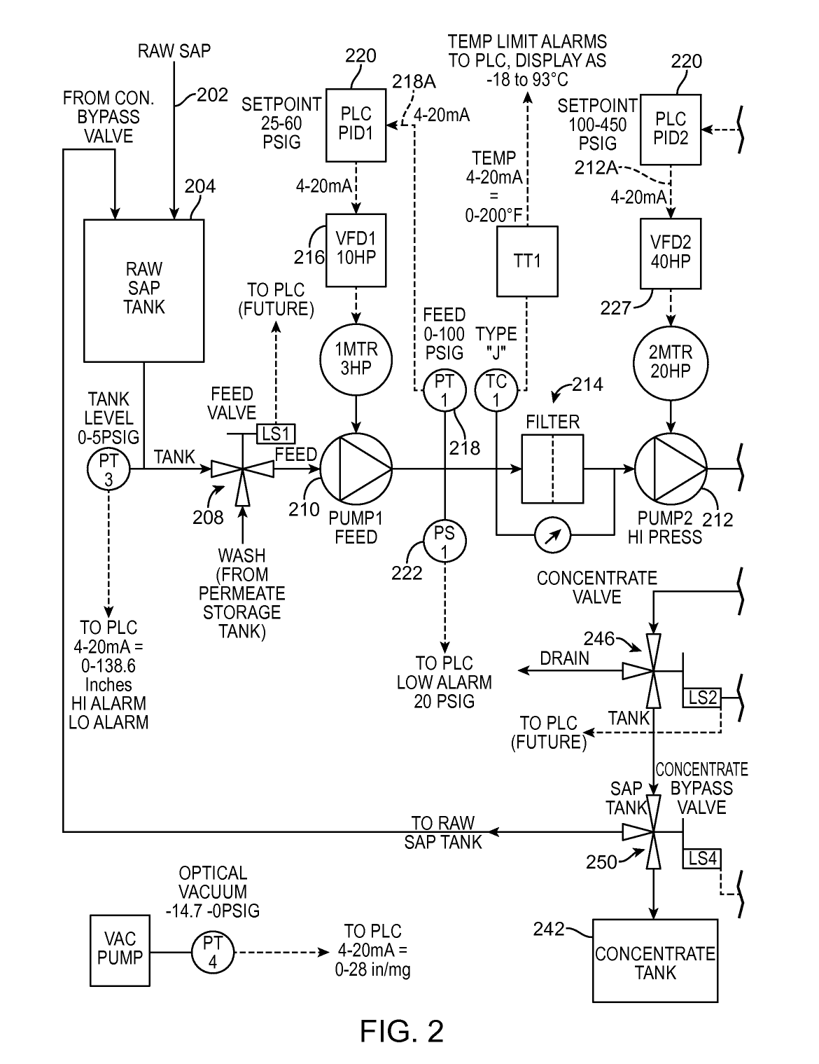

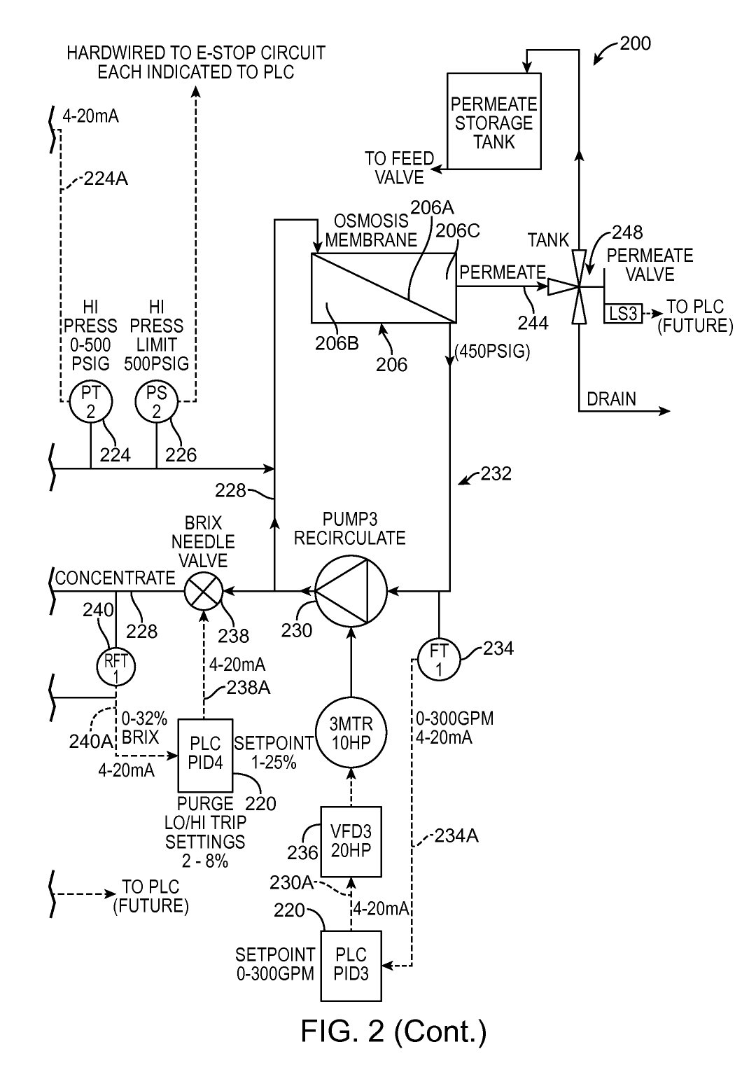

Referring now to the drawings, FIG. 1 illustrates an exemplary concentrator 100 made in accordance with the present invention. Concentrator 100 can be used, for example, to concentrate the sugar in a liquid, such as a raw natural liquid 102, for example, maple sap or coconut milk, to produce a concentrate 104. For ease of understanding, components of exemplary concentrator 100 will first be described generally, with further details provided thereafter. Then, a specific instantiation of concentrator 100 will be described with the aid of FIGS. 2-5.

With continuing reference to FIG. 1, concentrator 100 includes one or more reverse-osmosis (RO) units 106, which may be any one or more available RO units suitable for the type of liquid 102 being concentrated. Each RO unit 106 has a suitable RO membrane 106A that defines a concentrate side 106B and a permeate side 106C. RO unit(s) 106 are pressurized using one or more variable-output pressure pumps 108 having its output control by an appropriate feedback signal, such as from a pressure transducer 110 located upstream of the pressure pump(s). In one example, each variable-output pressure pump 108 is driven by a motor (not shown) controlled by a variable-frequency drive (not shown). Feedback from pressure transducer 110 can be directly to the variable-frequency drive, if present. However, in the embodiment shown, concentrator 100 includes a central controller 112, such as a programmable logic controller (PLC), system on chip, general purpose processor, etc., which receives a pressure signal 110A from pressure transducer 110 and outputs a corresponding pump-control signal 108A to each of pumps 108.

Depending on the nature of liquid 102 being input into concentrator 100, the concentrator may optionally include one or more filters 114 for removing any filterable material that may increase fouling of RO unit(s) 106. In this connection, concentrator 100 may also optionally include one or more variable-output feed pumps 116 that are controlled as a function feedback, such as from a pressure transducer 118 located between the feed pump(s) and filter(s) 114. As with pressure pump(s) 108, each variable-output feed pump 116 may be driven by a motor (not shown) controlled by a variable-frequency drive (not shown). Feedback from pressure transducer 118 can be directly to the variable-frequency drive, if present. However and as noted above, in the embodiment shown, concentrator 100 includes central controller 112 that receives a pressure signal 118A from pressure transducer 118 and outputs a corresponding pump-control signal 116A to each of pumps 116.

Concentrator 100 includes an input tank 120 that initially receives liquid 102. Concentrator 100 also includes a concentrate recirculation loop 122 that, during operation, recirculates concentrate 104 back to RO unit(s) 106 for further concentration of the sugar as desired or necessary. In this example, recirculation loop 122 includes one or more recirculation pumps 124. In some embodiments, each recirculation pump 124 is a fixed output pump. However, in other embodiments, each recirculation pump 124 is a variable output pump, which may be controlled using suitable feedback, such as feedback based on a flow transducer 126. In one example, each recirculation pump 124 is driven by a motor (not shown) controlled by a variable-frequency drive (not shown). Feedback from flow transducer 126 can be directly to the variable-frequency drive if present. However, in the embodiment shown, concentrator 100 includes central controller 112 that receives a flow signal 126A from flow transducer 126 and outputs a corresponding pump-control signal 124A to each pump 124.

In this example, concentrator 100 includes an inline sugar sensor 128, such as an inline refractometer, for measuring the concentration of sugar in concentrate 104 in the concentrator, such as in concentrate recirculation loop 122 as shown. Concentrator 100 also includes an automated concentrate draw valve 130 that allows concentrate 104 to be drawn out of the concentrator as output concentrate 132, which may be directed to a storage tank, evaporator, or other location. Concentrate draw valve 130 includes an actuator (not shown) responsive to a valve-control signal 130A generated, in this example, by controller 112, so as to open and close the valve. In the embodiment shown, sugar sensor 128 provides a concentration signal 128A that controller 112 uses to generate valve-control signal 130A, which opens and closes concentrate draw valve 130 according to system requirements to allow output concentrate 132 to flow more or less.

As those skilled in the art will readily appreciate, recirculation loop 122 recirculates concentrate 104 from concentrate side 106B of RO unit(s) 106 and back to the concentrate side of the RO unit(s) to essentially provide multiple passes through the RO unit(s) in order to continually remove water from the concentrate as permeate 134 that passes through RO membrane(s) 106A to permeate side 106C. Permeate 134 can be drawn from concentrator 100 and either discarded or used for a purpose, such as for washing and/or rinsing the concentrator, among other things. In this example, concentrator 100 further includes a user interface 136, such as a human-machine interface (HMI) that allows a human user to interact with controller 112, such as to view equipment statuses (e.g., pressures, flows, motor speeds, tank levels, etc.), set/change system parameters (e.g., pressure, flow, and/or brix % set points and/or motor and/or valve operating parameters, etc.), and switch operating modes (e.g., startup, concentration, rinse, wash, etc.), among other things.

In some embodiments, concentrator 100 may additionally and optionally include one or more flow distributors 138 to improve the performance of RO units 106. Exemplary flow distributors suitable for use as flow distributor(s) 138 are outlined in U.S. Pat. No. 6,139,750 titled “WATER DESALINATION” and issued on Oct. 31, 2000, in the name of Graham (“the '750 patent”), which is incorporated herein by reference for its descriptions concerning flow distribution and flow distributors in the context of reverse osmosis membranes. In one example, and as shown in the '750 patent, the flow distributor is comprised of a flat plate with holes drilled in it. The holes distribute the flow and twist the flow to a turbulent state, thus distributing the flow. This has reduced fouling, increased flows (permeate flux rates), and reduced down times for cleaning.

With exemplary concentrator 100 of FIG. 1 in mind, aspects of the inventions described herein started out by the present inventors recognizing deficiencies in typical conventional practices of maple syrup producers for reducing water in maple sap, i.e., concentrating the sugar in the maple sap, which is typically done by reverse osmosis in a concentrator. In a conventional concentrator, maple sap is pressurized and subjected to a semi-permeable membrane that allows water molecules to pass and retains sugar molecules. The sugar content of raw maple sap as taken from a maple tree can range anywhere from about 0.9% (and lower) to about 2.5% (and higher). Depending on the maple-syrup producer, the maple sap is brought to a concentration of generally 10-21% sugar content in a concentrator prior to subjecting the concentrate to an evaporation process that results in the final syrup product. Some producers may choose to concentrate to higher or lower concentrations than what was just specified. In any event, by applying pressure to maple sap in a reverse osmosis system, the water content is greatly reduced, thus reducing the boiling time required to make maple syrup. This reduces heating-fuel costs and other indirect costs that make this process advantageous to perform.

A basis of one aspect of the present inventions is controlling the speed of the reverse osmosis process by increasing and reducing pressure automatedly as needed. As maple sap increases in concentration, the osmotic pressure also increases. Osmotic pressure is the pressure needed for the water molecules to separate and be removed from the solution, here, the maple sap. Traditionally and as noted in the Background section above, original equipment manufacturers (OEMs) of reverse osmosis systems in the maple syrup industry, i.e., “concentrators,” equip their systems with a hand-operated valve to allow a concentrator operator to reduce system pressure. Typically, OEM concentrators include a number of high pressure pumps, along with one or more feed pumps, and one or more recirculation pumps. The nature of a reverse osmosis system allows for high pressures to be built to overcome osmotic pressure. The way all OEMs known to the present inventors reduce pressure in their systems is to either reduce the amount of concentrate leaving the system using a valve (often referred to as a “concentrate valve”), remove pressure using another valve (often referred to as a “high pressure control valve”), or by using multiple pumps staged on or off as needed to achieve the desired pressure. Both of these valves, i.e., the concentrate valve and the high pressure control valve, are hand operated. The current OEMs use fixed speed pumps and motors. In contrast, some embodiments of the present invention utilize one or more variable speed pumps (e.g., using variable frequency motor drives) that allow not only for fine pressure control but also for efficient operation.

In addition to controlling pressure with one or more feedback-controlled variable-output pumps (e.g., pressure pump(s) 108 of FIG. 1), such as one or more variable-speed pumps, in some embodiments of the present invention the concentrate output is controlled automatedly. As mentioned above and in contrast, conventional OEM equipment utilizes the above-mentioned hand-operated valves. In certain embodiments of the present invention, an automatedly controlled valve, such as concentrate draw valve 130 of FIG. 1, allows concentrate to leave the concentrator at a desired brix % in accordance with measurements made by a suitable sugar sensor, such as sugar sensor 128 of FIG. 1. In one particular embodiment, the concentrator is plumbed so that an inline sugar sensor (e.g., refractometer) samples the concentrate for brix % continuously, and through a control system, such controller 112 of FIG. 1, controls the brix % via the automatedly actuated valve.

In the embodiments shown in the drawings, an inline sugar sensor (an inline refractometer) is located in the recirculation loop between the recirculation pump and the high-pressure pump. However, in other embodiments, the sugar sensor can be located elsewhere in the concentrator, including upstream of the feed pump. In this connection, those skilled in the art will readily appreciate that knowing the brix % at any point within the concentrator and knowing all of the relevant system parameters allows the brix % to be calculated at any other point within the concentrator. That said, locating the sugar sensor in the recirculation loop, or at an effluent point in the concentrator allows for direct measurement of the brix % of the concentrate that is taken out of the concentrator.

In one example, the interface an operator has with the concentrator is via an HMI (see, e.g., user interface 136 of FIG. 1), which in the one instantiation includes a touchscreen device. In an exemplary embodiment, the controller, such as controller 112 of FIG. 1, enables an operator to set the desired parameters of the system with the HMI. One of the features of the present invention is that system pressure is controlled automatedly. The controller controls system pressure by using pressure transducers that measure pressure at various locations within the concentrator system. The transducers signal back to the controller, e.g., PLC, which, when an HMI is present, further signals to the HMI to display actual pressures, including the system pressure. In one instantiation, a single feed pump (e.g., pump 116 of FIG. 1) is in series with a single pressure pump (e.g., pump 108 of FIG. 1), and the single high pressure pump is in parallel with a single recirculation pump (e.g., pump 124 of FIG. 1). This arrangement of pumps allows for pressure between the feed pump and the high pressure pump to be additive to the pressure of the high pressure pump. It is noted that while such an instantiation has one of each pump type, in other systems there may be two or more of each pump type, and in yet other systems the feed and high pressure pumps can be integrated into a single pump.

In some embodiments, a feed pressure transducer (such as pressure transducer 118 of FIG. 1), which may be located between a feed pump (see, e.g., feed pump(s) 116 of FIG. 1) and a high-pressure pump (see, e.g., pressure pump(s) 108 of FIG. 1), is a key player in controlling the feed pump. The high pressure transducer (such as pressure transducer 110 of FIG. 1), which is located between the high pressure pump and the osmotic membrane(s) or at any other point in the system that is at a high pressure, is what controls the overall system pressure. In some embodiments, a concentrator of the present disclosure is unique in the sense that it automates pressure control. Again, in one example, this automation is effected by using both a PLC and a HMI working together. As alluded to above, the process of automatedly controlling the system pressure could be done without the PLC and HMI, such as by using a dedicated controller, general purpose computer, etc. Thus, the PLC and the HMI are not mandatory for implementing automated pressure control. The system could simply be controlled by using the equipped programming of a variable frequency drive (VFD) that does or does not include a proportional-integral-derivative (PID) loop.

Secondly the concentration of the output of the concentrator, i.e., the concentrate output (see, e.g., output concentrate 132), can also be controlled electronically. It is noted that automated concentrate concentration control can be implemented separately from the automated pressure control, but for the greatest benefit, they should be implemented together. In one embodiment, measurements from an inline sugar sensor (e.g., sugar sensor 128 of FIG. 1) are used to control an automatedly actuated valve (e.g., draw valve 130 of FIG. 1) that affect the concentration of the concentrate that is taken out of the system. In a particular example, the sugar sensor senses the concentration of the sugar in the concentrate flowing at one point in the system in real time and sends a signal back to the controller. When the controller is a PLC and an HMI is coupled to the PLC, the PLC can cause the HMI to display a brix %. In addition to displaying this information, the controller can be programmed so that the user can set a desired brix %, and the controller will work to automatically achieve this set value. In one embodiment, this is done by modulating the valve to stay with a set parameter.

### Exemplary Liquid Path

In an exemplary concentrator, such as concentrator 100 of FIG. 1, the initial liquid 102 starts by being pumped by feed pump 116. Feed pump 116 pushes liquid 102 through filter 114 that pre-filters the liquid. This pre-filtering reduces particles to keep the osmotic membrane(s) 106A from fouling as quickly, and the filtering also protects pumps 108, 116, and 124. Controller 112 is configured to maintain positive pressure on the intake of high-pressure pump 108. This helps prevent damage to high-pressure pump 108.

At the exit of high-pressure pump 108, liquid 102 is pumped at high pressure into the plumbing of reverse osmosis unit(s) 106 so that it is pushed into membrane housing(s) (not shown) wherein membrane(s) 106A is/are housed. This is where the pressure forces liquid 102 to travel through semi-permeable RO membranes 106A used in the relevant industry. A single pass of liquid 102 through osmotic membrane(s) 106A will not generate enough permeate 134 to bring the sugar concentration of concentrate 104 up to a desired level. Concentrate 104 will travel through RO unit(s) 106, and with recirculation loop 122 will be brought back full circle in concentrator 100 by the use of recirculation pump(s) 124.

Recirculation pump(s) 124 will maintain liquid flowing across or through RO membrane(s) 106A. By removing recirculation pump(s) 124 from concentrator 100, the performance of the concentrator will greatly reduce, and eventually the concentrator will not work. In one embodiment, concentrate 104 is bled off recirculation loop 122 between the outlet(s) of recirculation pump(s) 124 and the outlet(s) of high-pressure pump(s) 108. In addition, this is where inline sugar sensor 128 and automatedly actuated draw valve 130 may lie. That said, in other embodiments, concentrate 104 can be bled off concentrator 100 as output concentrate 132 at another location, and inline sugar sensor 128 can also be located elsewhere in the concentrator, as noted above.

If concentrate 104 is desired at a higher concentration brix %, an operator simply inputs the desired brix % into controller 112 via user interface 136, and by using the output of sugar sensor 128, the controller automatedly adjusts automatedly actuated draw valve 130 to maintain the desired concentration. Concentrate 104 must remain in concentrator 100 longer to achieve higher concentrations, and inversely stay in the concentrator a shorter period of time for lower concentrations. The length of time in concentrator 100, i.e., the amount of recirculation, is what dictates the removal of permeate 134, as well as the concentration brix % of concentrate 104. Permeate 134 travels to the inside(s) of RO membrane(s) 106 and is brought to either a drain or stored, for example, for cleaning purposes. That is the complete fluid path of an exemplary instantiation of concentrator 100 made in accordance with features of the present disclosure.

### Pressure Control Basis

A basis behind using automated pressure control is that RO membranes and filters will foul, and then pressures will increase. On the feed side of an RO concentrator unit, if there is a fouled filter the pressure on the feed side of the filter will increase and the pressure on the outlet side of the filter will decrease. This can be caused by many things, but one thing specific is that the initial full pumping pressure of a system has been shown to greatly reduce filter life. At higher pressures, the filter will typically become fouled much sooner and reduce overall flow through that filter before the filter needs changing. In addition and as noted above, with conventional concentrators pressure is regulated by hand, and if the operator allows the concentrator to run unchecked for too long, the system pressures can rise, exacerbating the fouling problem because of the high pressures. Soft starting the concentrator and being able to set the feed pressure of a concentrator of the present disclosure, such as concentrator 100 of FIG. 1, increases filter life. The filters can operate at half the pressure of a standard filter that does not have pressure control.

As just mentioned, over time, RO membranes will foul with organic matter, and this fouling will drive up the system pressure. It's common for an operator to leave a conventional OEM concentrator at a set pressure and come back an hour or many hours later to find the pressure has increased. The increase in pressure can change the system characteristics. The set pressure would have been set with the high pressure control valve. By using this valve, essentially the extra energy output of the high pressure pump is dumped back to the feed side of the concentrator, which is at low pressure. This is very energy inefficient. An automated system made in accordance with the present disclosure will maintain a constant pressure that is set. Over time, as the RO membrane(s) foul(s), the variable speed pumps increase speed to achieve the desired set pressure, or decrease and at the same time to automatically adjust the concentration brix %. This way there is no wasted energy when it comes to the high pressure pump. The energy that is needed is demanded of the pump specifically and does not just use what is needed from what a non-controlled pump outputs.

Concentrate Control Basis

On a similar basis as pressure control, with constant valve settings concentrator concentration can creep over time. A user of a conventional OEM concentrator generally sets the concentration of the reverse osmosis concentrator system to a certain brix %. Over time, the actual value changes due to the system pressures changing coupled with fouling of the RO membrane(s). A user may set a desired brix % and come back many hours later to find the concentrator at a brix % far from what was set. A concentrator made in accordance with the present disclosure, however, can incorporate an inline sugar sensor, such as sugar sensor 128 of FIG. 1, and include a controller, such as controller 112 of FIG. 1, that automatedly modulates an actuated valve, such as draw valve 130 of FIG. 1, so as to maintain a constant brix %. This is beneficial, since an operator can leave the concentrator without worry about system parameters changing. If they do change, the controller will automatedly compensate for the changes and make adjustments as needed. This allows the concentrator to operate consistently and without intervention and/or human monitoring. Often times the feed tank for a concentrator can become layered with different concentrations. A set brix % on a conventional OEM concentrator will change simply from the input brix % changing over time.

### System Control and Energy Savings

In exemplary embodiments that use variable frequency drives to effect the variable-output pumps, such as pumps 108, 116, and 124 of FIG. 1, by using variable frequency drives to control system pressures, not only does the concentrator operate on a more regulated and automated basis, it also uses less energy than conventional concentrators. The use of soft start electric motors, along with reducing pump speeds as needed, reduce electrical consumption. The soft start of electric motors reduces demand charges imposed on customers by electrical suppliers. The reduced demand reduces the rate at which further electrical consumption is billed. Controlling pumps for speed uses only the amount of electricity that is absolutely needed, not excessive electricity, which is how the other OEMs are operating.

### Exemplary Instantiation Description

FIG. 2 illustrates a specific instantiation 200 of concentrator 100 of FIG. 1 intended for use in concentrating the sugar content of maple sap 202. As will be seen, components of concentrator 200 are discussed as the sap touches or is controlled by each component.

Referring now to FIG. 2, sap 202 is fed from a raw-sap tank 204 to an RO unit 206. Before sap 202 is allowed to be pumped into RO unit 206, it is passed through a valve 208 that can allow water, sap, or any other solution, such as a cleaning solution, into concentrator 200. Valve 208 or series of valves, which could be a series of tanks, is described in FIG. 2. Valve 208 may be designed to be monitored for position and/or controlled electronically. Following valve 208 or series of tanks is a feed pump 210. Feed pump 210 keeps positive pressure on the inlet side of a high-pressure pump 212 and also provides flow through a pre-filter stage 214 of concentrator 200. Feed pump 210 is powered with the feed-pump variable frequency drive 216, and feedback of the system pressure is given by a feed pressure transducer 218 located downstream of pre-filter stage 214. Feed pressure transducer 218 sends a pressure signal 218A to a PLC 220, which controls feed-pump variable frequency drive 216 via a pump-control signal 210A. Along with feed pressure transducer 218, there is a feed pressure switch 222 that is a safety protecting high-pressure pump 212 from low flows/pressure.

Downstream from high-pressure pump 212, there are both a high-pressure transducer 224 and a high-pressure switch 226. High-pressure transducer 224 works identically to feed-pressure transducer 218 by sending a signal 224A to PLC 220, which sends a pump-control signal 212A to a high-pressure variable frequency drive 227 of high-pressure pump 212. High-pressure switch 226 is set to limit system pressure for safety reasons.

Sap 202 next travels to RO unit 206 and, following that, to the RO membrane(s) 206A within the unit. The effluent sap, i.e., concentrate 228, from the concentrate side 206B of membrane(s) 206A next travels to a recirculation pump 230. Recirculation pump 230 keeps concentrate 228 in concentrator 200 moving and by doing so reduces the fouling of RO membranes 206A.

In concentrator instantiation 200 shown in FIG. 2, a recirculation loop 232 is controlled using a flow transducer 234. Flow transducer 234 sends a flow signal 234A to PLC 220, which sends a pump-control signal 230A to a recirculation-pump variable frequency drive 236 to control the speed of the recirculation pump.

On the return end of recirculation loop 232 and in concentrator instantiation 200 shown, concentrate 228 can be removed from the loop via an automatedly actuated valve called in this example the brix needle valve 238. After brix needle valve 238, concentrate 228 is continuously monitored by an inline refractometer 240 that sends a signal 240A back to PLC 220, which in response generates a valve-control signal 238A to control the brix needle valve. As those skilled in the art will readily appreciate, brix needle valve 238 is initially open only a small amount, for example 2% or less, to let just enough concentrate 228 through to sugar sensor, here, refractometer 240, so that the sugar sensor can obtain concentration readings. This small opening of brix needle valve 238 to provide a reading flow is maintained by PLC 220 until the brix level, as determined via sugar sensor 240 reaches the desired, preset level, at which time the PLC is programmed to open the brix needle valve to allow more of concentrate 228 to be drawn off of recirculation loop 232 to provide a removal flow. In one example, the early, less concentrated, concentrate drawn off of recirculation loop 232 in the reading flow is sent to a concentrate tank 242. This is typically not an issue due to the relatively small volume of low-concentration concentrate produced until concentration levels are at or close to the desired concentration level. However, in other embodiments, it is noted that this low-concentration concentrate can be sent, for example, to sap tank 204. In addition, it is noted that recirculation loop 232 shown can be modified, such as by sending the recirculated concentrate back to raw-sap tank 204. Those skilled in the art will understand that other configurations are also possible. In some embodiments in which a needle valve is used, such as with brix needle valve 238, the opening of the needle valve to provide the removal flow may be in a range of 10% to 15% of full opening. In other embodiments, the amount of opening of the concentrate draw valve may be different than that range. In a specific instantiation of sugar concentrator 200 shown in which brix needle valve 238 is a ½-inch NPT (national pipe thread) needle valve, an initial opening of 5% of full-open has provided excellent results for retaining sugar within concentrator 200 while maintaining sufficient flow across refractometer 240 to allow the refractometer to measure the concentration of concentrate 228 drawn off of recirculation loop 232. During operation when the concentration of the sugar in concentrate 228 is at or near the desired sugar-concentration setpoint, concentrator 200 automatedly opens value to openings in a range of about 8% to about 12% of full-open for the ½-inch NPT needle valve to draw concentrate of the desired concentration off of recirculation loop 232.

The products of concentrator 200, i.e., concentrate 228 and a permeate 244, are controllably discharged from the outlet valves 246 and 248 to respected locations for use as concentrated sap or water, respectively, to produce maple syrup. These valves are shown as concentrate valve 246 and permeate valve 248, respectively, in FIG. 2. Oftentimes, producers collect the built-up sugar in a concentrator when rinsing the system. This is typically called “purging.” The present system uses a concentrate bypass valve 250 to select the location of the rinse product, whether it be concentrate tank 242 or raw-sap tank 204. Each producer may choose to do this slightly differently.

Those skilled in the art will readily appreciate that each of the features described above, such as the pressure control feature, the concentration control feature, and the flow distribution feature, can be implemented together, separately from one another, and in any subcombination, as desired to suit a particular application.

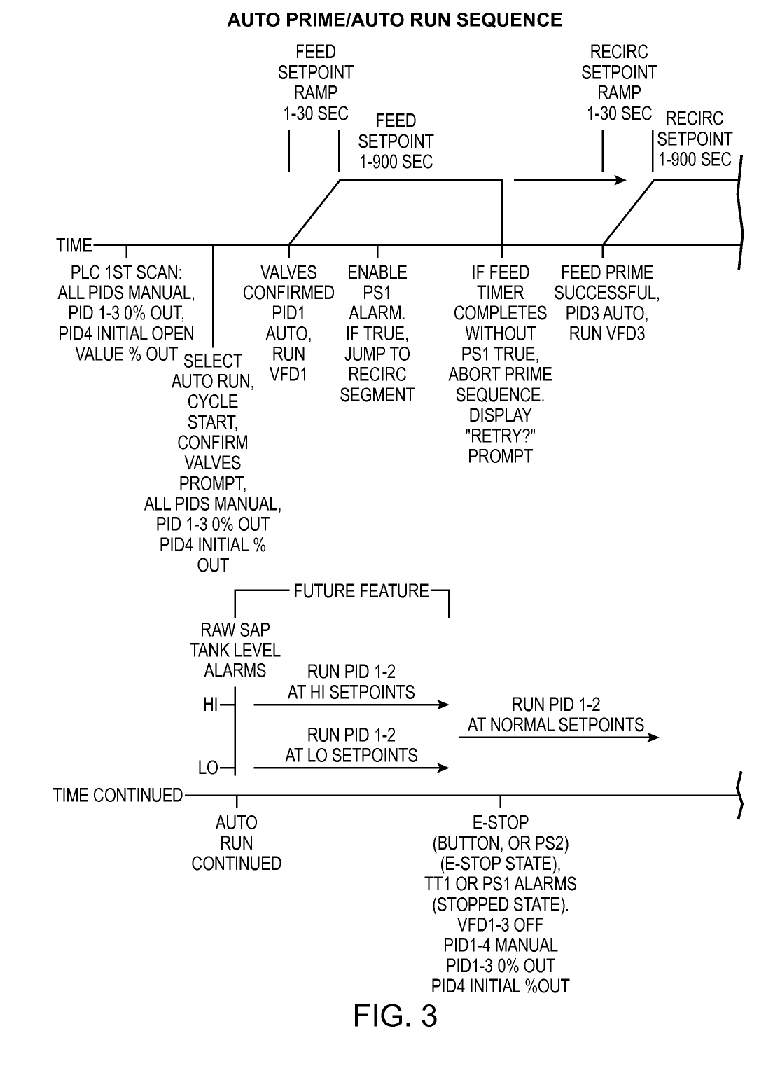

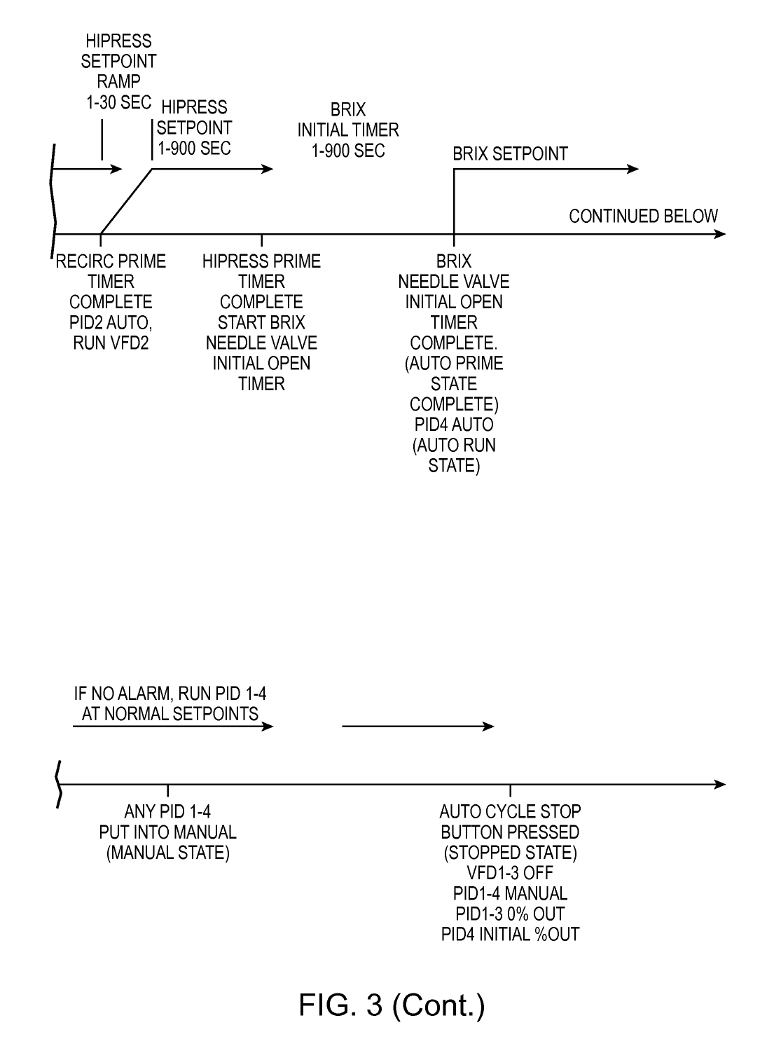

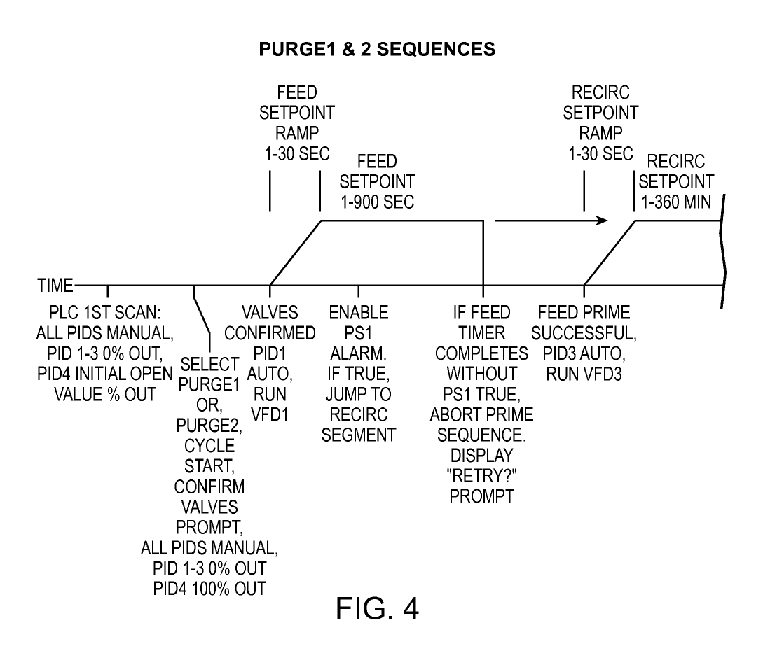

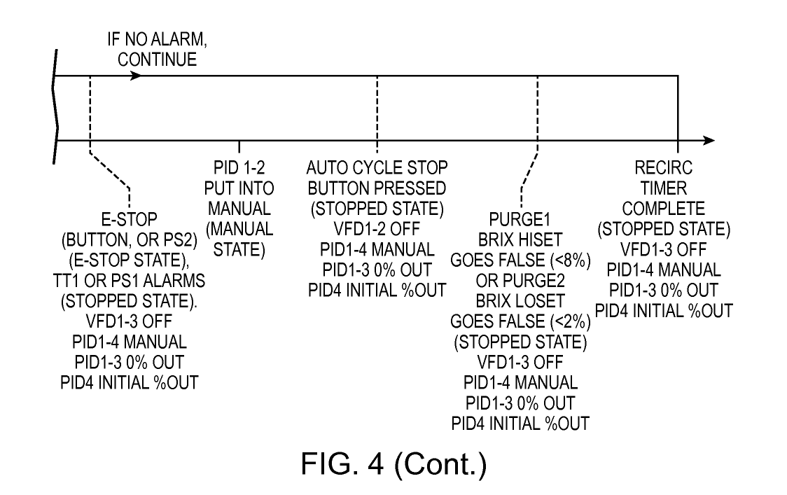

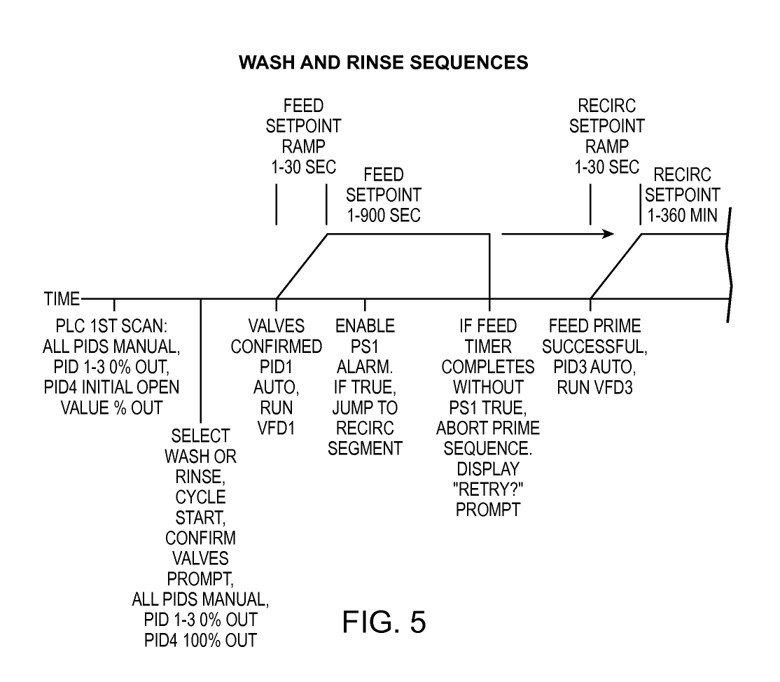

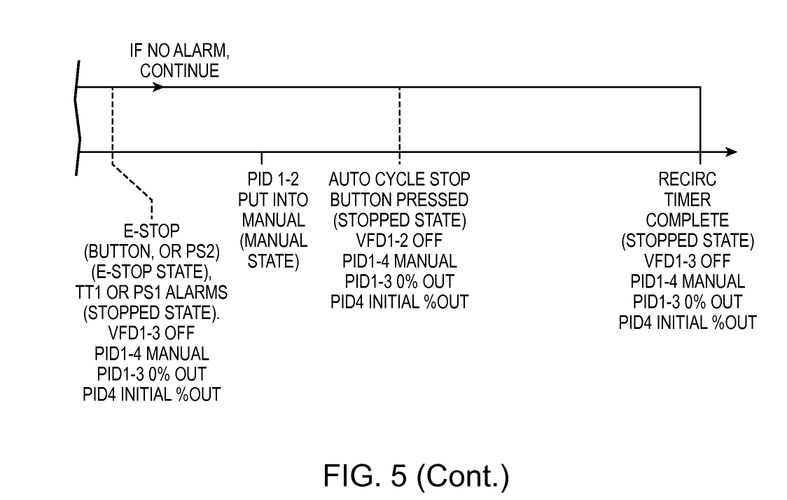

Also attached are FIGS. 3-5, which illustrate various additional automation features that can be implemented using a suitable controller, such as PLC 220 used to implement the pressure and concentration control features of concentrator 200 of FIG. 2 described above. FIG. 3 illustrates auto-prime and auto-run sequences, FIG. 4 illustrates purge sequences, and FIG. 5 illustrates wash and rinse sequences. As those skilled in the art will readily appreciate, these additional automation features can greatly benefit sap sugar concentration operations. Skilled artisans will readily understand how to implement these additional automation features.

The amount of sugar in raw maple sap taken directly from a maple tree can range anywhere from about 0.9% (and lower) to about 2.5% (and higher). Depending on the maple producer, the maple sap is brought to a concentration of generally 10-21% sugar content prior to subjecting the concentrate to an evaporation process that results in the final syrup product.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of increasing sugar concentration in a liquid containing sugar, comprising:
receiving a sugar-concentration setpoint;
providing the liquid to an inlet to a concentrate side of a reverse-osmosis (RO) unit under an RO pressure that causes water in the liquid to permeate through an RO membrane of the RO unit to a permeate side of the RO unit;
recirculating a concentrate of the liquid from an outlet of the concentrate side of the RO unit to the inlet of the concentrate side of the RO unit;
automatedly monitoring the sugar concentration of the concentrate to obtain a sugar-concentration measurement;
automatedly comparing the sugar-concentration measurement to the sugar-concentration setpoint; and
when the sugar-concentration measurement is equal to or greater than the sugar-concentration setpoint, automatedly actuating a concentrate-draw valve to draw concentrate from said recirculating.

2. A method according to claim 1, wherein said providing the liquid to an inlet to a concentrate side of an RO unit includes:
automatedly monitoring the RO pressure upstream of the outlet of the concentrate side of the RO unit to obtain an RO-pressure signal; and
automatedly adjusting the RO pressure as a function of the RO-pressure signal.

3. A method according to claim 2, wherein said automatedly adjusting the RO pressure includes automatedly controlling a pressure pump so as to adjust the RO pressure.

4. A method according to claim 3, wherein said automatedly controlling a pressure pump includes controlling a variable frequency drive of the pressure pump.

5. A method according to claim 2, wherein said recirculating a concentrate includes recirculating the portion of the concentrate in a concentrate recirculation loop located downstream of the pressure pump.

6. A method according to claim 5, wherein said automatedly monitoring the sugar concentration includes:
drawing a portion of the concentrate from the concentrate recirculation loop; and
using a sugar sensor to obtain the sugar measurement.

7. A method according to claim 6, wherein said drawing a portion of the concentrate from the recirculation loop includes drawing the portion of the concentrate from the recirculation loop using the concentrate draw valve.

8. A method according to claim 2, further comprising:
pre-filtering the liquid using a filter located upstream of the pressure pump;
automatedly measuring a filtered-liquid pressure at a location downstream of the filter to obtain a filtered-liquid-pressure signal; and
automatedly adjusting the filtered-liquid pressure as a function of the filtered-liquid-pressure signal.

9. A method according to claim 1, wherein said automatedly monitoring the sugar concentration includes:
drawing a portion of the concentrate from a concentrate recirculation loop; and
using a sugar sensor to obtain the sugar measurement.

10. A method according to claim 9, wherein said drawing a portion of the concentrate from the recirculation loop includes drawing the portion of the concentrate from the recirculation loop using the concentrate draw valve.

11. A method according to claim 1, further comprising introducing diffusion into flow of the concentrate within the RO unit.

12. A sugar concentrator designed and configured to increase the concentration of sugar in a liquid, comprising:
a reverse-osmosis (RO) unit containing an RO membrane defining a concentrate side and a permeate side of said RO unit, said concentrate side having a liquid inlet and a concentrate outlet, and said permeate side having a permeate outlet;
a feed system designed and configured to feed the liquid to said liquid inlet of said RO unit;
a recirculation loop fluidly coupling said concentrate outlet of said RO unit to said liquid inlet of said RO unit so as to recirculate a concentrate from said concentrate side of said RO unit back to said concentrate side during operation of the sugar concentrator;
an automated concentrate draw valve fluidly coupled to said recirculation loop so as to controllably draw a portion of the concentrate off of said recirculation loop during operation of the sugar concentrator, said automated concentrate draw valve responsive to a valve-control signal so as to change flow of the concentrate through said automated concentrate draw valve during operation of the sugar concentrator;
a sugar sensor designed and configured to automatedly sense a sugar concentration of the concentrate recirculating in said recirculation loop during operation of the sugar concentrator, wherein said sugar sensor generates a sugar-concentration-measurement signal as a function of the sugar concentration; and
a controller in operative communication with each of said sugar sensor and said automated concentrate draw valve, said controller designed and configured to generate the valve-control signal as a function of the sugar-concentration-measurement signal.

13. A sugar concentrator according to claim 12, wherein said feed system includes:
a system pressure transducer located upstream of said outlet of said concentrate side of said RO unit, said system pressure transducer designed and configured to measure a first pressure of the liquid entering said concentrate side of said RO unit and to generate a first pressure signal representing the first pressure during operation of the sugar concentrator; and
a variable-output pressure pump fluidly coupled to said liquid inlet of said concentrate side of said RO unit, said variable-output pressure pump responsive to a pressure-pump-control signal;
wherein said controller is operatively coupled to said system pressure transducer and said variable-output pressure pump and is designed and configured to generate said pressure-pump-control signal as a function of said first pressure signal so as to inhibit a rate of fouling of said RO membrane when the sugar concentrator is operating.

14. A sugar concentrator according to claim 13, wherein said feed system further includes a filter fluidly coupled to said variable-output pressure pump upstream of said variable-output pressure pump.

15. A sugar concentrator according to claim 14, wherein said variable-output pressure pump has a liquid inlet and said feed system further includes:
a feed pressure transducer located between said filter and said variable-output pressure pump, said feed pressure transducer designed and configured to measure a second pressure of the liquid entering said variable-output pressure pump during operation of the sugar concentrator; and
a variable-output feed pump fluidly coupled to said filter and located fluidly upstream of said filter, said variable-output feed pump responsive to a feed-pump-control signal;
wherein said controller is operatively coupled to said feed pressure transducer and said variable-output feed pump and is designed and configured to generate said feed-pump-control signal as a function of said second pressure signal so as to maintain a positive pressure of the liquid at said liquid inlet of said variable-output pressure pump when the sugar concentrator is operating.

16. A sugar concentrator according to claim 13, wherein said recirculation loop is configured to recirculate the concentrate to said feed system at a location fluidly downstream of said variable-output pressure pump.

17. A sugar concentrator according to claim 16, wherein said recirculation loop includes:
a flow transducer designed and configured to measure a flow of the concentrate in said recirculation loop and to generate a flow signal representing the flow during operation of the sugar concentrator; and
a recirculation pump designed and configured to controllably recirculate concentrate output from said concentrate outlet, said recirculation pump responsive to a recirculation-pump-control signal;
wherein said controller is operatively coupled to said flow transducer and said recirculation pump and is designed and configured to generate the recirculation-pump-control signal as a function of the flow signal.

18. A sugar concentrator according to claim 12, wherein said automated concentrate draw valve has a low-pressure outlet and said sugar sensor is located fluidly downstream of said low-pressure outlet.

19. A sugar concentrator according to claim 18, wherein said controller is designed and configured to:
compare the sugar concentration to a sugar-concentration setpoint corresponding to a desired concentration at which the concentrate is to be drawn off of said recirculation loop;
when the sugar concentration is lower than the setpoint, control said automated concentrate draw valve to provide a reading flow; and
when the sugar concentration is equal to or greater than the setpoint, control said automated concentrate valve to provide a removal flow that is greater than the reading flow.

20. A sugar concentrator according to claim 12, further comprising a flow diffuser located so as to diffuse flow of the concentrate in said concentrate side of said RO unit.
